(19) United States
(12) Patent Application Publication
(10) Pub. No.: US 2019/0345961 A1
(43) Pub. Date: Nov. 14, 2019

(54) TENSION CONNECTOR AND FIXING ARRANGEMENT HAVING SUCH A TENSION CONNECTOR

(71) Applicant: Häfele Berlin GmbH & Co KG, Berlin (DE)

(72) Inventors: Gunter Nitschmann, Pfalzgrafenweiler (DE); Gerd Sawatzki, Rauen (DE)

(21) Appl. No.: 16/522,389

(22) Filed: Jul. 25, 2019

Related U.S. Application Data
(63) Continuation of application No. PCT/EP2017/065949, filed on Jun. 28, 2017.

(30) Foreign Application Priority Data
Mar. 6, 2017 (DE) 20 2017 101 263.8

(51) Int. Cl. F16B 2/18; F16B 12/20; A47B 88/919

(52) U.S. Cl. CPC F16B 2/185; A47B 2088/939; A47B 88/919; F16B 12/2036

(57) ABSTRACT

A tension connector connecting two components includes a bolt which has a bolt shaft and a bolt head. An eccentric lever has a bearing pot with a pot opening and with a pot interior which is formed as a pivoting bearing and by means of which the eccentric lever can be or is mounted on the bolt head so as to be pivotable about a pivot axis between a starting position and a tensioned position. The bearing pot has a slot for the bolt shaft, extending from the pot opening against the tensioning direction and, along the slot, has an outer contour which is eccentric relative to the pivot axis.

### CROSS-REFERENCE TO RELATED APPLICATIONS

This continuation application claims priority to PCT/EP2017/065949 filed on Jun. 28, 2017 which has published as WO 2018/162090 A1 and also the German application number 20 2017 101 263.8 filed on Mar. 6, 2017, the entire contents of which are fully incorporated herein with these references.

### FIELD OF THE INVENTION

The invention relates to a tension connector for connecting two components, comprising a bolt which has a bolt shaft and a bolt head, and an eccentric lever which is pivotably mounted on the bolt head and fixedly clamps the two components together in its tensioned position, and relates to a fixing arrangement with such a tension connector.

### BACKGROUND OF THE INVENTION

EP 0 878 630 A2 discloses a tension connector with an eccentric lever, which is fixedly mounted on a spreading part so as to be pivotable about a pin between a starting position and a tensioned position. The pin defines the pivot axis and is pressed into the eccentric lever. The tension connector thus consists of three parts: eccentric lever, spreading part and pin. A dowel arranged on the spreading part is used to insert the tension connector in a bore of the first component. When the eccentric lever is pivoted into its tensioned position, the spreading part is drawn relative to the dowel, which thereby spreads out and is anchored in the bore.

In contrast, it is an object of the invention to provide a simple, universal tension connector and a fixing arrangement with such a tension connector.

### SUMMARY OF THE INVENTION

This object is achieved according to the invention by a tension connector for connecting two components, comprising a bolt which has a bolt shaft and a bolt head, and an eccentric lever which has a bearing pot with a pot interior which is formed as a pivoting bearing, by means of which the eccentric lever is mounted on the bolt head so as to be pivotable about a pivot axis between a starting position and a tensioned position, wherein the bearing pot has a slot for the bolt shaft extending from the pot opening in the pivot direction and, along the slot, has an outer contour which is eccentric relative to the pivot axis.

According to the invention, clamping takes place without tools by means of a separate eccentric lever which simultaneously forms the clamping or holding means for a component to be fixed, so no additional tools are required for creating or releasing the connection and no additional fittings need be permanently attached to the part to be connected. The tension connector according to the invention therefore consists of only two parts: the bolt and the eccentric lever.

Since the pivot axis of the eccentric lever is already established by the slot passing through the bolt shaft, the bolt head on its side facing the bolt shaft and the pot interior may be formed as a partial sphere or partial cylinder.

In order, in the case of an eccentric lever made of plastic, to connect the bolt and the eccentric lever together captively, the slot advantageously has an elastically widenable constriction between the pot opening and the starting position of the bolt, the slot width of which is slightly smaller than the diameter of the bolt shaft. The bolt is clicked or latched into the eccentric lever by widening the constriction. In the case of an eccentric lever made of a metal material, e.g. a zinc die-casting, tabs (rivet webs) are provided on both sides of the slot and can be bent into the slot to reduce the slot width. After insertion in the slot, the bolt is secured to the eccentric lever by bending (riveting) the tabs.

Particularly preferably, the distance of the eccentric outer contour from the pivot axis against the tensioning direction increases continuously up to the pot base, and transitions into the pot base via an edge in order to secure the eccentric lever in the tensioned position. In addition or alternatively, the eccentric lever may be self-locking by an over-tensioning shortly before the tensioned position. Because of the over-tensioning, the tension path rises only up to shortly before the pot base and then self-locking occurs by relief of tension.

A further component may be attached to the bearing pot of the eccentric lever and be secured to the eccentric lever by a collar surrounding the pot opening.

The end of the bolt remote from the bolt head may advantageously be anchored as an insert in a plastic injection molding, or have a thread or at least one spreading cone which cooperates e.g. with a spreading sleeve clipped thereon.

The eccentric lever may advantageously be configured as a carrier part, in particular for push-fit connection of a further component, or have a receptacle which, in the tensioned position of the tension connector, is open in the direction transversely to the bolt axis of the bolt, in order to suspend a further component therein.

Preferably, the eccentric lever has a pin protruding on its back side pointing in the tensioning direction, in order to further support the eccentric lever on the component.

Preferably, the eccentric lever is a one-piece component, in particular made of plastic or zinc die-cast, and the bolt is a steel part, in particular a steel extrusion.

The invention also relates to a fixing arrangement for fixing components with at least one tension connector as described above.

A preferred refinement of the fixing arrangement comprises two components lying against each other, wherein the bolt of the tension connector is attached to the one component and protrudes with its bolt head from the other component, and wherein the eccentric lever of the tension connector fixedly clamps the two components together in the tensioned position. Preferably, in the tensioned position, the eccentric lever bears with its lever arm on the second component and is thereby latched on the second component. Advantageously, a further component may be attached to the eccentric lever, in particular by means of a keyhole.

Another preferred refinement of the fixing arrangement comprises two side walls, between which a further component, e.g. a shelf or a clothes rail, is attached by means of tension connectors, the tension bolts of which are anchored in the two side walls, and the eccentric levers of which mounted on the bolt heads are fixedly clamped to the side wall, wherein the further component is held suspended from the eccentric levers.

Further advantages of the invention arise from the description, the claims and the drawings. Also, the above-mentioned features and those presented below may be used individually or in groups in arbitrary combinations. The embodiments shown and described should not be regarded as a definitive list, but rather have an exemplary character for presenting the invention.

### BRIEF DESCRIPTION OF THE DRAWINGS

In the drawings:

FIG. 1 shows a tension connector according to the invention with a bolt and an eccentric lever in the state not yet mounted;

FIGS. 2a-2d show the individual mounting steps for mounting (FIGS. 2a, 2b) the tension connector of FIG. 1, and the mounted tension connector in its starting position (FIG. 2c) and in its tensioned position (FIG. 2d);

FIGS. 3a, 3b show a plastic handle with two tension connectors according to the invention (FIG. 3a), the bolts of which are anchored in the handle as inserts, and the handle mounted on a furniture wall (FIG. 3b);

FIG. 4 shows a modified handle with two tension connectors according to the invention, the bolts of which are screwed into the handle;

FIGS. 5a, 5b show a tension connector according to the invention with a spreading bolt and a spreading sleeve clipped thereon (FIG. 5a), and during clamping of two components (FIG. 5b);

FIG. 6 shows a further component which is suspended on the tension connector of FIG. 5;

FIGS. 7, 8 show in each case, two components which are clamped together by means of two tension connectors;

FIGS. 9a-9e show the individual mounting steps for fixing a shelf to two side walls by means of two tension connectors;

FIGS. 10a-10d show the individual mounting steps for fixing a clothes rail to two side walls by means of two tension connectors; and

FIG. 11 shows an adapter plate for fixing a drawer guide to a furniture body by means of a tension connector.

### DETAILED DESCRIPTION OF THE PREFERRED EMBODIMENTS

In the following description of the figures, the same reference signs are used for the same components or those with similar function.

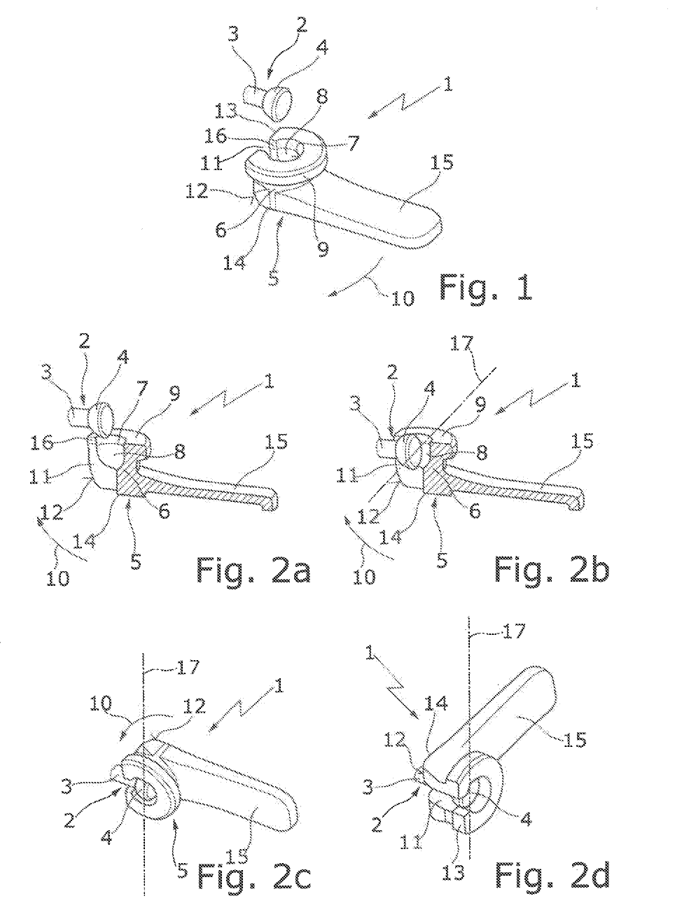

The tension connector 1 shown in FIGS. 1 and 2 for connecting two components comprises a bolt 2 with a bolt shaft 3 and a bolt head 4, and an eccentric lever 5 which comprises a bearing pot 6 with a pot opening 7 and with a pot interior 8 which is configured as a pivot bearing in the form of a quarter- to half-sphere. On its bolt side facing the bolt shaft 3, the bolt head 4 is configured to be hemispherical. Preferably, the bolt 2 is a turned part made of steel, and the eccentric lever 5 is a one-piece plastic part or zinc die-casting. Instead of being formed as a partial sphere, the bolt head 4 and the pot interior 8 may alternatively be formed as a partial cylinder.

The pot opening 7 may optionally be surrounded by a collar 9 which protrudes radially outwardly over the pot wall. The bearing pot 6 has a slot 11 extending from the pot opening 7 against the tensioning direction 10 of the eccentric lever 5, and an outer contour 12 on both sides of the slot 11 which is eccentric relative to the pivot axis 8. The collar 9 is configured as a ring segment, the two end faces of which together define a flat contact face 13 on both sides of the slot 11. The distance of the outer contour 12 from the pot interior 8 increases continuously in the tensioning direction 10 from the flat contact face 13 to the flat pot base 14, wherein the eccentric outer contour 12 transitions into the pot base 14 via an edge. The flat lever arm 15 of the eccentric lever 5 grips on the pot base 14 on the side of the bearing pot 6 opposite the slot 11, and runs approximately parallel to the collar 9. In the case of an eccentric lever 5 made of plastic, the slot 11 has an elastically widenable constriction 16 close to the pot opening 7, in particular at the height of the collar 9, the slot width of which constriction is slightly smaller than the diameter of the bolt shaft 3.

On mounting of the tension connector 1, the eccentric lever 5 with its pot opening 7 is pressed onto the bolt head 4 at right angles to the bolt axis, and at the same time the bolt shaft 3 is introduced into the slot 11 (FIG. 2a). The constriction 16 is elastically widened to the diameter of the bolt shaft 3 until it latches behind the bolt shaft 3 which has been pressed past it, whereby the bolt 2 and the eccentric lever 5 are captively held together (FIG. 2b). In the case of an eccentric lever 5 made as a zinc die-casting, rivet webs (not shown) are provided on both sides of the slot 11 and are bent or riveted after the bolt shaft 4 has been laid in the slot 11, in order to secure the bolt 2 to the eccentric lever 5.

With its hemispherical pot interior 8, the eccentric lever 5 is mounted on the hemispherical bolt head 4 so as to be pivotable through 90° about a pivot axis 17, which is defined by the slot 11 passing through the bolt shaft 3, between a starting position (FIG. 2c) and a tensioned position (FIG. 2d). In the starting position, the lever arm 15 is oriented parallel to the bolt 2, and lies with its constriction 16 against the bolt shaft 3. In the tensioned position, the lever arm 15 is oriented at right angles to the bolt 2.

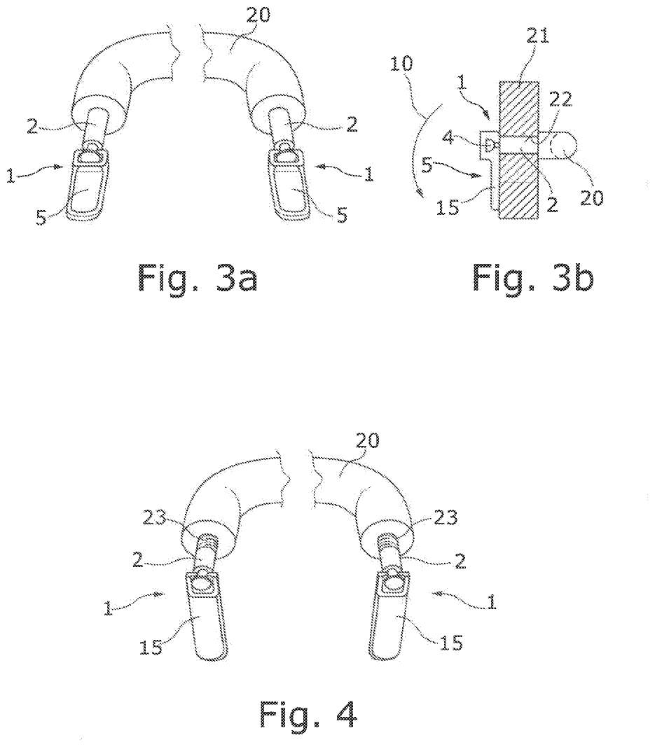

In FIGS. 3a, 3b, a plastic handle 20 is attached to a furniture wall 21 by means of two tension connectors 1, the bolts 2 of which are anchored as inserts in the handle 20. The bolts 2 are each pushed through a bore 22 in the furniture wall 21 until their bolt heads 4 protrude from the bore 22 on the back of the furniture wall 21. Then the eccentric levers 5 are push-fitted onto the bolt heads 4 and latched, as described above. From this starting position, the eccentric levers 5 are each pivoted through 90° in the tensioning direction 10 until, in the tensioned position, the handle 20 is firmly clamped to the furniture wall 21 by the eccentric outer contours 12 of the eccentric levers 5 which roll on the back side of the furniture wall 21. In the tensioned position, each eccentric lever 5 lies with its flat pot base 14 on the back side of the furniture wall 21, wherein the edge present between the eccentric outer contour 12 and the pot base 14 secures the eccentric lever 5 in the tensioned position. Alternatively or additionally, self-locking of the eccentric lever 5 may take place by an over-tensioning shortly before the tensioned position. In the tensioned position, the lever arm 15 runs parallel to and spaced from the furniture wall 21, so that to remove the handle 20, the eccentric lever 5 can easily be pivoted manually back into the starting position.

The handle 20 shown in FIG. 4 differs from the handle shown in FIG. 3 only in that here, the two bolts 2 are each screwed into the handle 20 via a thread 23.

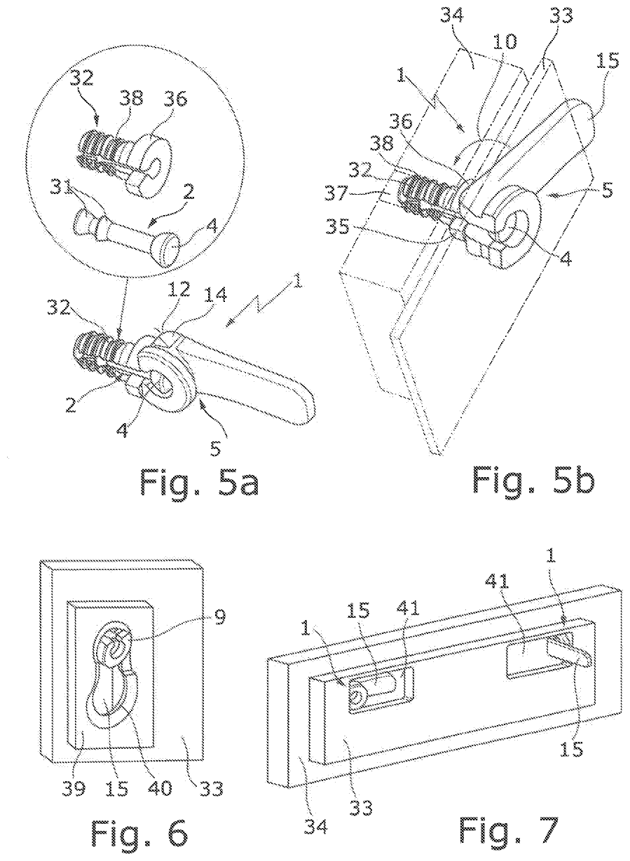

In FIGS. 5a, 5b, the bolt 2 of the tension connector 1 is formed as a spreading bolt with two spreading cones 31, onto which a longitudinally slotted, plastic spreading sleeve 32 is clipped. Alternatively, the spreading bolt 2 may also be an insert in a plastic molding. In order to connect together two adjacent components (e.g. furniture panels) 33, 34, the spreading sleeve 32 is clipped onto the bolt 2 as a first mounting step, and then this spreading bolt is pre-mounted on the first component 33 to be fixed in that the bolt head 4 is pushed through a bore 35 of the first component 33, and then the eccentric lever 5 is push-fitted onto the bolt head 4 and latched as described above. The tension connector 1, which is secured against falling out of the bore 35 firstly by the edge collar 36 of the spreading sleeve 32 and secondly by the eccentric lever 5, is now pre-mounted on the first component 33. The end customer may take the first component 33 and insert this, with the spreading sleeve 32 of the pre-mounted tension connector 1, into the bore 37 of the other second component 34 until the two components 33, 34 lie against each other, and the edge collar 36 of the spreading sleeve 32 is received in the stepped bore 37 of the second component 34. Then the eccentric lever 5 is pivoted through 90° in the clamping direction 10. The eccentric outer contour 12 rolling on the first component 33 here firstly causes the spreading bolt 2 to be drawn slightly out of the spreading sleeve 32 (held stationary by the second component 34), wherein the spreading sleeve 32 is spread outwards due to the spreading cones 31, and secondly causes the two components 33, 34 to be drawn together and thereby fixedly clamped against one another. In addition, the spreading sleeve 32 comprises several peripheral ribs 38 which, on spreading of the spreading sleeve 32, dig into the bore wall of the second component 34 and thus fixedly anchor the spreading sleeve 32 in the bore 37. In the tensioned position, the eccentric lever 5 with its flat pot base 14 and its lever arm 15 bears on the first component 33, wherein the edge present between the eccentric outer contour 12 and the pot base 14 secures the eccentric lever 5 in the tensioned position. In addition, the eccentric lever 5 may be self-locked by an over-tensioning shortly before the tensioned position. Because the tension connector 1 is pre-mounted on the first component 33, the end customer has no individual fixing elements and the mounting steps for the end customer are simple, intuitive and rapid. Naturally, in principle, other mounting sequences are possible.

FIG. 6 shows a further component 39 with an upwardly tapering keyhole 40 on the tension connector 1, namely on the bearing pot 6 between the radially outwardly protruding collar 9 and the first component 33. The diameter of the lower keyhole half is greater than the outer diameter of the collar 9, and the diameter of the upper keyhole half corresponds to the outer diameter of the bearing pot 6.

FIG. 7 shows the first component 33 mounted on the second component 34 by means of two tension connectors 1, the lever arms 15 of which each lie on the base of a rectangular recess 41 of the first component 33 in the tensioned position. The depth of the recesses 41 corresponds at least to the height of the tension connectors 1, which are thereby completely sunk into the recess 41.

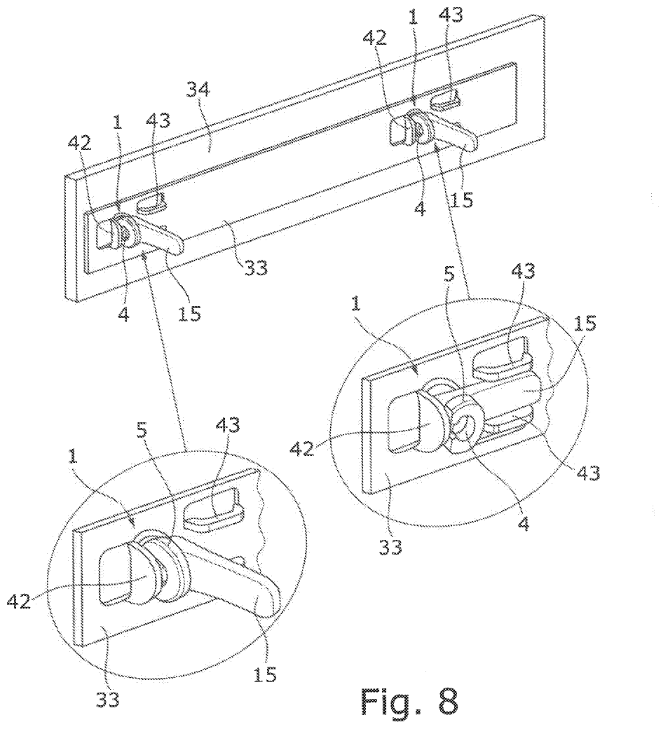

In FIG. 8, the first component 33 is a sheet metal part with two openings (not shown) through which the bolt heads 4 of two clamping pins 2 anchored in the second component 34 protrude. The openings are each adjoined by a vertical tab 42 on the left and two horizontal tabs 43 arranged each above each other on the right, each of which are bent forward out of the sheet metal part. The eccentric lever 5 of the tension connector 1 on the left in FIG. 8 is shown in its starting position, and the eccentric lever 5 of the tension connector 1 on the right is shown in its tensioned position, in which the lever arm 15 lies parallel against the first component 33. In this tensioned position, the eccentric lever 5 is secured in that firstly its contact face 13 lies flat against the vertical tab 42, and secondly the lever arm 15 is received between the horizontal tabs 43 and latched.

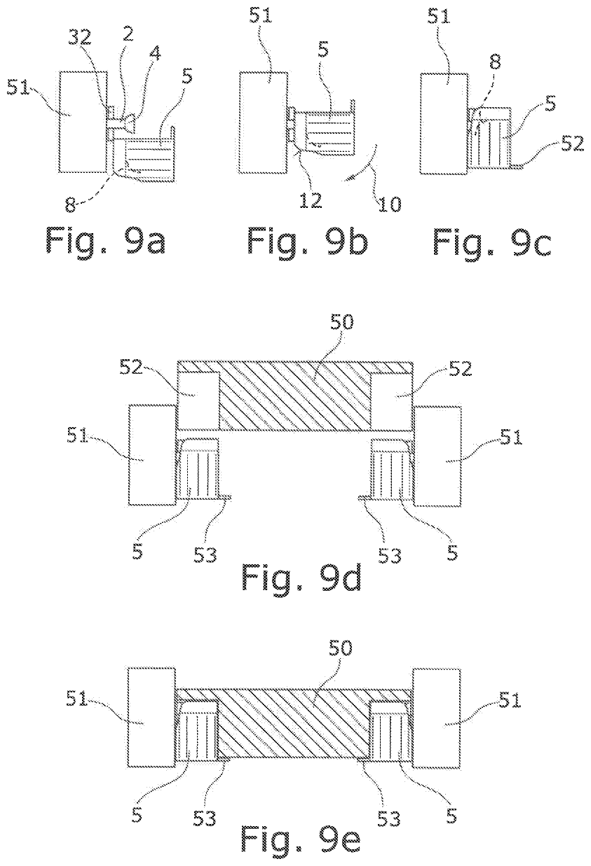

FIGS. 9a-9e show the mounting steps for fixing a shelf 50 between two side walls 51 by means of two tension connectors 1. Firstly, the tension bolt 2 is anchored in the side wall 51, e.g. by means of the spreading sleeve 32 (FIG. 9a), and then the eccentric lever 5 is push-fitted onto the bolt head 4 from below and latched as described above (FIG. 9b). From this horizontal starting position, the eccentric lever 5 is pivoted downward by 90° in the tensioning direction 10 until, in the vertical tensioned position, the eccentric lever 5 is fixedly clamped to the side wall 51 by its eccentric outer contour 12 rolling on the side wall 51, and bears against this (FIG. 9c). The shelf 50, with its laterally open, bottom-side blind bores 52, is push-fitted from above onto the two eccentric levers 5 formed as cylindrical carrier parts (FIG. 9d), until it lies on a floor protrusion 53 of the eccentric lever 5 (FIG. 9e). The two eccentric levers 5 are secured in their tensioned position by the shelf 50 resting thereon.

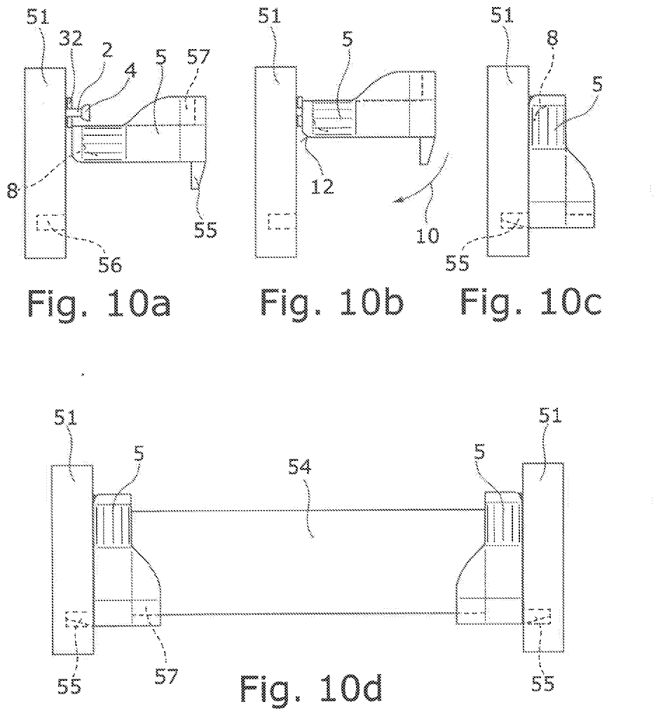

FIGS. 10a-10d show the individual mounting steps for fixing a clothes rail 54 between two side walls 51 by means of two tension connectors 1. Firstly, the tension bolt 2 is anchored in the side wall 51, e.g. by means of the spreading sleeve 32 (FIG. 10a), and then the eccentric lever 5 is push-fitted onto the bolt head 4 from below and latched as described above (FIG. 10b). From this horizontal starting position, the eccentric lever 5 is pivoted downward by 90° in the tensioning direction 10 until, in the vertical tensioned position, the eccentric lever 5 is fixedly clamped to the side wall 51 by its eccentric outer contour 12 rolling on the side wall 51, and bears against this (FIG. 10c). Also, the eccentric lever 5 has a pin 55 on its contact side which, in the vertical tensioned position, fits tightly into a hole 56 in the side wall 51. The clothes rail 54 is placed from above in a receptacle 57, open at the top, of the eccentric lever 5 (FIG. 10d) which, in the tensioned position of the tension connector 1, is open in the direction transversely to the bolt axis of the bolt 2. The two eccentric levers 5 are secured in their tensioned position by the suspended clothes rail 54. For fixing other components, the receptacle 57, provided for insertion or suspension of components on the eccentric lever 5, would have to be configured differently according to the component.

For the simple, intuitive and rapid mounting described above, in contrast to the mounting shown in FIGS. 9 and 10 in which the bolt 2 and eccentric lever 5 are only assembled by the end customer of the tension connector 1 on site, the spreading bolt, i.e. the bolt 2, and spreading sleeve 32 and the eccentric lever 5 are already pre-mounted by latching or riveting, i.e. the end customer need merely insert the spreading sleeves 32 of the pre-mounted tension connectors 1 in the bores in the side wall 51 and swivel the eccentric levers 5.

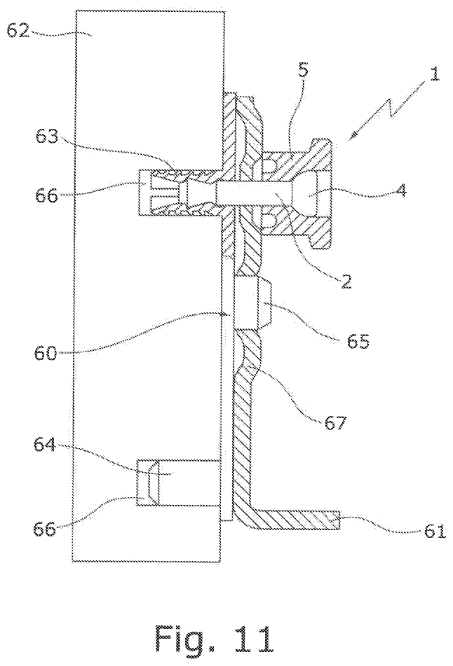

FIG. 11 shows a plastic adapter plate 60 for fixing a drawer guide 61, shown here merely in extract, to the side wall 62 of a furniture body by means of a tension connector 1. A spreading sleeve 63, with molded tension bolt 2, and a push-fit pin 64 are molded onto one plate side of the adapter plate 60, and a latching pin 65 is molded onto the other plate side. The distance between the spreading sleeve 63 and the push-fit pin 64 corresponds to the hole spacing of a series of holes in the side wall, i.e. in the present case, to the distance between the two bores 66 of the side wall 62. The locking pin 65 is in the middle between the spreading sleeve 63 and the push-fit pin 64. The adapter plate 60 with its bolt head 4 is pushed through a hole of a fixing plate 67 of the drawer guide, and latched to the fixing plate 67 by means of the latching pin 65. Then the eccentric lever 5 is push-fitted onto the bolt head 4 and latched. The fixing plate 67 pre-mounted in this way is inserted with the spreading sleeve 63 and push-fit pin 64 into the two bores 66 of the side wall 62; finally, the eccentric lever 5 is swiveled, whereby the adapter plate 60 and hence also the fixing plate 67 are attached to the side wall 62. The adapter plate 60 thus assumes the function of the spreading sleeve, and also defines the correct spacing (clamping dimension) and improves the force transmission to the drawer guide 61 through the two push-fit and latching pins 64, 65 arranged on both sides, whereby transverse and shear forces can be substantially better absorbed than via a spreading connector alone.

What is claimed is:

1. A tension connector for connecting two components, comprising:
a bolt which has a bolt shaft and a bolt head formed as a partial sphere or partial cylinder on its bolt side facing the bolt shaft; and
an eccentric lever which has a bearing pot with a pot opening and with a pot interior which is formed as a partial sphere or partial cylinder and is formed as a pivoting bearing and by means of which the eccentric lever can be or is mounted on the bolt head so as to be pivotable about a pivot axis between a starting position and a tensioned position;
wherein the bearing pot has a slot for the bolt shaft extending from the pot opening against the tensioning direction and has an outer contour along the slot which is eccentric relative to the pivot axis;
wherein the end of the bolt remote from the bolt head has at least one spreading cone, onto which a spreading sleeve is attached; and
wherein the slot has an elastically widenable constriction between the pot opening and the starting position of the bolt, the slot width of which constriction is slightly smaller than the diameter of the bolt shaft, whereby the eccentric lever can be push-fitted and latched onto the bolt head.

2. The tension connector as claimed in claim 1, wherein the lever arm of the eccentric lever in the starting position is oriented parallel to the bolt.

3. The tension connector as claimed in claim 1, wherein the distance of the eccentric outer contour from the pivot axis against the tensioning direction increases continuously up to the pot base and transitions into the pot base via an edge.

4. The tension connector as claimed in claim 1, wherein the lever arm of the eccentric lever acts on the pot base.

5. The tension connector as claimed in claim 1, wherein the pot opening is surrounded by a collar.

6. The tension connector as claimed in claim 1, wherein the bearing pot has a flat contact face on the side of the slot.

7. The tension connector as claimed in claim 1, wherein the eccentric lever is configured as a carrier part for push-fit connection of a further component.

8. The tension connector as claimed in any of claim 1, wherein the eccentric lever has a receptacle which, in the tensioned position of the tension connector, is open in the direction transversely to the bolt axis of the bolt.

9. The tension connector as claimed in claim 1, wherein the eccentric lever has a pin protruding on its back side pointing in the tensioning direction.

10. The tension connector as claimed in claim 1, wherein the eccentric lever is a one-piece component made of plastic or a zinc die-casting.

11. A fixing arrangement for fixing the two components with at least one tension connector as claimed in claim 1.

12. The fixing arrangement as claimed in claim 11, with the two components lying against each other, wherein the bolt of the tension connector is attached to the one component, and with its bolt head protrudes from the other component, and wherein in the tensioned position, the eccentric lever of the tension connector fixedly clamps the two components together.

13. The fixing arrangement as claimed in claim 12, wherein in the tensioned position, the eccentric lever bears with its lever arm on the one component.

14. The fixing arrangement as claimed in claim 12, wherein in the tensioned position, the eccentric lever is latched with its lever arm on the one component.

15. The fixing arrangement as claimed in claim 12, wherein a further component is attached to the eccentric lever.

16. The fixing arrangement as claimed in claim 11, including two side walls, between which a further component is attached by means of two of the tension connectors, wherein the bolts of each tension connector is anchored into its respective side wall, and the eccentric levers mounted on the bolt heads are fixedly clamped to their respective side walls, and that the further component is held suspended from the eccentric levers.
